(19) United States
(12) Patent Application Publication
(10) Pub. No.: US 2026/0120720 A1
(43) Pub. Date: Apr. 30, 2026

(54) GENERATIVE VIDEO CAMERA CONTROLS FOR INPUT VIDEOS

(71) Applicant: Google LLC, Mountain View, CA (US)

(72) Inventors: Nataniel Ruiz Gutierrez, Brookline, MA (US); Neal Wadhwa, East Setauket, NY (US); Junhao Zhang, Singapore (SG); Shiran Zada, Tel Aviv (IL); Rony Paiss, Givataim (IL); Inbar Mosseri, Raanana (IL); Nikhil Karnad, Mountain View, CA (US)

(21) Appl. No.: 19/376,811

(22) Filed: Oct. 31, 2025

Related U.S. Application Data
(60) Provisional application No. 63/714,792, filed on Oct. 31, 2024.

(51) Int. Cl. G11B 27/031; G06T 7/246; G06T 7/55

(52) U.S. Cl. CPC G11B 27/031; G06T 7/246; G06T 7/55; G06T 2207/10016; G06T 2207/10028; G06T 2207/20081; G06T 2207/20084

(57) ABSTRACT

Methods and systems for generating output videos that have new camera motion. For example, an output video can be generated using a generative neural network from an input video and new camera motion data specifying a new camera motion that is different from the input camera motion of the input video.

### CROSS-REFERENCE TO RELATED APPLICATION

This application claims priority to U.S. Provisional Application No. 63/714,792, filed on Oct. 31, 2024. The disclosure of the prior application is considered part of and is incorporated by reference in the disclosure of this application.

### BACKGROUND

This specification relates to processing images using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that generates an output video from an input video of a scene. The output video has different camera motion from the input video of the scene. In particular, the system can receive, e.g., from a user, an input that specifies a new camera motion and then generate an output video that depicts the scene as if it had been captured by a camera with the new camera motion instead of the camera motion when the input video was captured.

The subject matter described in this specification can be implemented in particular embodiments so as to realize one or more of the following advantages.

This specification describes techniques for using a video generation neural network, e.g., a video diffusion neural network, to change the camera motion of an input video, i.e., to generate a new output video that depicts the same scene as the input video but with different camera motion. Thus, the described techniques allow a user to effectively “control” the camera motion of a given video by submitting an input that identifies the given video and that specifies the desired camera motion for the output video.

Some existing attempt to allow for controllable camera trajectories in generated videos. However, these methods cannot be directly applied to user-provided videos that are not generated by a video model. This specification, by contrast, describes techniques for generating new videos with novel camera trajectories from a single user-provided video. Thus, the described techniques can re-generate the reference input video, with all its existing scene motion, from vastly different angles and with cinematic camera motion. Notably, the described techniques can also plausibly predict parts of the scene that were not observable in the reference video.

In particular, the described techniques first generate a noisy anchor video with the new camera trajectory, e.g., using multi-view diffusion models or depth-based point cloud rendering, and then regenerate the anchor video into a clean and temporally consistent reangled video using the video generation neural network. By first generating the noisy anchor video, the described techniques allow the video generation neural network to correct issues in the anchor video, significantly improving the quality of the final generated output video. Moreover, by first generating the noisy anchor video, the described techniques do not require the video generation neural network to directly generate the output video from the input video and instead provide the video generation neural network with an intermediate representation of the output video that the video generation neural network can refine, resulting in significantly improved output video quality.

More generally, effectively generating new videos with user-specified camera motion from an existing user-provided video that contains complex scene motion is an open and challenging problem. For example, the task is inherently ill-posed due to the limited amount of information in the reference video: one cannot know how exactly the scene looks from other angles if there is not full knowledge of the scene's 4D content, i.e., content in a four-dimensional (4D) coordinate system that includes three spatial dimensions and a fourth time dimension. In other words, the scene's 4D content includes the content of the scene both across time and from different angles within a three-dimensional (3D) coordinate system. However, this does not preclude an approximate solution that is plausible and appreciated by users.

Some existing approaches generate an output video by assuming the availability of synchronized multi-viewpoint videos and constructing 4D neural representations. Other existing approaches allow construction using a single monocular video, but require accurate camera pose and depth estimation, and cannot capture content outside the original field of view.

The described techniques alleviate the need for synchronized multi-viewpoint videos or accurate camera pose and depth estimation while still generating plausible content outside the original field of view, e.g., by performing the video-to-video translation described above using the video generation neural network. For example, the described techniques leverage the prior knowledge of video generative models, in both image and video domains, to effectively reangle the video as if filmed from the requested camera trajectory.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF DRAWINGS

FIG. 1A shows an example video generation system.

FIG. 1B shows examples of videos generated by the system.

FIG. 2 is a flow diagram of an example process for generating an output video with new camera motion.

FIG. 3 shows an example of generating an anchor video using point cloud representations.

FIG. 4 shows an example of generating an anchor video using a multi-video diffusion neural network.

FIG. 5 shows an example of the operation of the system when generating an output video from an anchor video.

Like reference numbers and designations in the various drawings indicate like elements.

### DETAILED DESCRIPTION

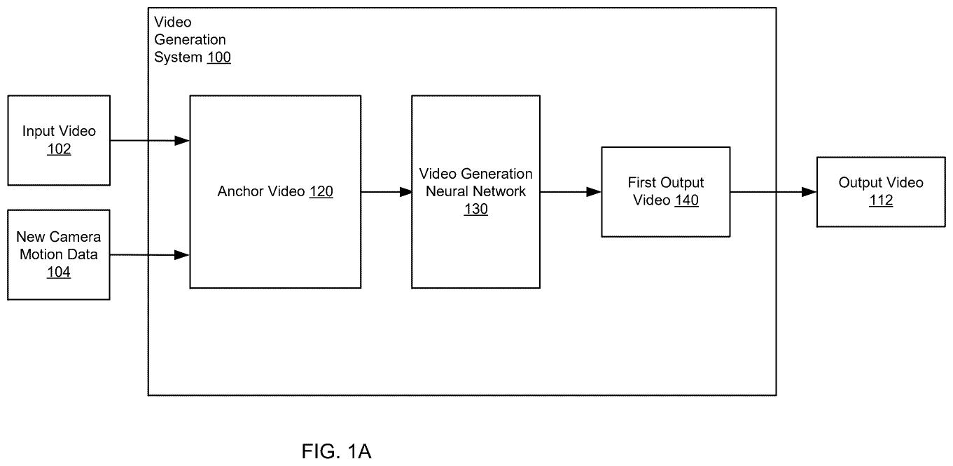

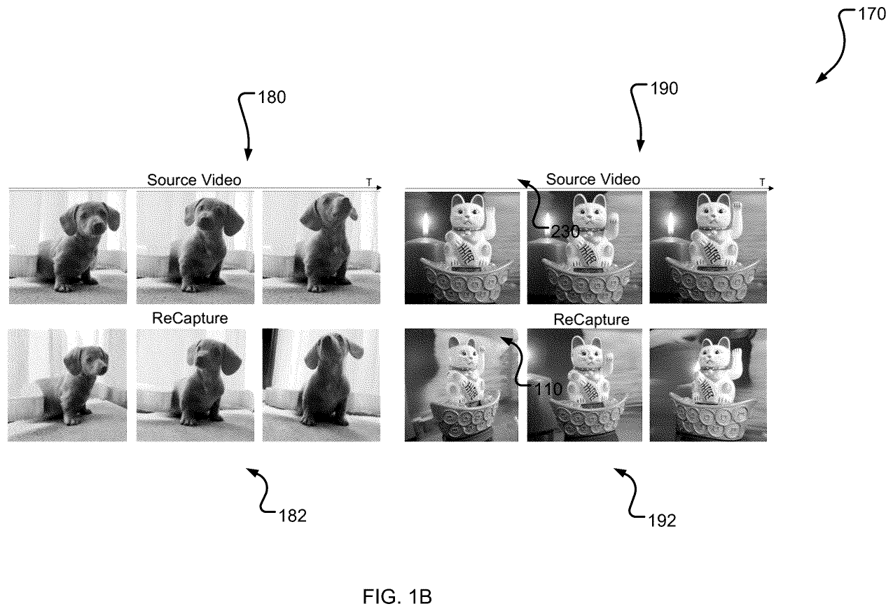

FIG. 1A shows an example video generation system 100. The video generation system 100 is an example of a system implemented as computer programs on one or more computers in one or more locations, in which the systems, components, and techniques described below can be implemented.

The system 100 generates an output video 112 from an input video 102 of a scene.

The input video 102 has a respective input video frame at each of a sequence of time steps and can be received as input, e.g., from a user. For example, the user can upload the input video 102 to the system 100 or can provide a link to or other identifier for the input video 102 to the system 100.

In particular, the input video 102 has an input camera motion. That is, the input video was captured (or appears as if it was captured) using a camera that had an input motion trajectory while the input video 102 was being captured. For example, the camera may have been static or may have been moving along a particular dynamic trajectory during the time window spanned by the input video. Thus, the appearance of the scene as depicted in the input video is impacted both by the scene motion, i.e., the motion of objects in the scene, and camera motion, i.e., the motion of the camera.

To generate the output video 112, the system 100 receives new camera motion data 104 that specifies a new camera motion that is different from the input camera motion. That is, the new camera motion data 104 specifies a camera trajectory that is different from the input motion trajectory. More specifically, the new camera motion data 104 defines a respective camera pose and orientation at each of the time steps in the input video, with the pose, orientation, or both at one or more of the time steps being different from the corresponding pose or orientation at the same time step specified by the input camera motion for the input video.

The system 100 then generates an output video 112 of the same scene as the input video but that has the new camera motion (instead of the input camera motion). In other words, the output video 112 is a video of the scene that appears as if it was captured using a camera that had the new motion trajectory while the output video was being captured.

As part of generating the output video 112, the system 100 first generates, from the input video 102 of the scene and the new camera motion data 104, an anchor video 120 with the new camera motion.

The anchor video 120 has a respective anchor video frame at each of the sequence of time steps. Generally, the anchor video 120 is an “initial” video with the new camera motion and the anchor video frames can be incomplete.

For example, the anchor video frames can have artifacts such as missing information from revealed occlusions as a result of the change in camera motion between the two videos and temporal inconsistencies such as flickering as a result of the change in camera motion between the two videos.

The system 100 can generate the anchor video 120 in any of a variety of ways. For example, the system 100 can generate the anchor video 102 by performing image-based view synthesis, in which the system 100 independently transforms each input video frame to produce noisy anchor frames with the new camera pose. These frames are inherently noisy because each anchor video frame is generated independently from only the corresponding input frame, preventing the anchor video from incorporating information from other times in the video that may be relevant in accounting for the change in camera pose at any given time.

This can be done using any appropriate image view synthesis technique. For example, the system can generate each anchor frame using point cloud representation of the corresponding input video frame or by using a multi-view diffusion neural network to transform the corresponding input frame into the anchor frame. These examples will be described in more detail below.

However, because the anchor video 120 is incomplete as described above, one or more pixels in some or all of the anchor frames will generally be invalid, i.e., will not have a corresponding pixel in the corresponding initial video frame due to the change in camera motion, e.g., because the pixel was not in the field of view of the camera given the input camera motion or because the pixel depicts a portion of the scene that has become occluded due to the change in camera motion.

In some cases, the system 100 can generate a validity mask that “masks out” these invalid pixels. For example, the system 100 can identify each pixel in a given anchor video frame that does not have a corresponding pixel in the corresponding input video frame, i.e., corresponds to a portion of the scene that was not in the field of view of the camera given the input camera motion but is now in the field of view of the camera given the new camera motion, and assign that pixel a value of zero or another value that indicates that the pixel is invalid in the validity mask for the given anchor video frame, while assigning pixels that do have corresponding pixels in the corresponding input video frame values of one or other values that indicate that the pixel is valid in the validity mask.

The system 100 then processes an input that includes the anchor video 120 using a video generation neural network 130 to generate a first output video 140 with the new camera motion.

In other words, the system 100 uses the video generation neural network 130 to correct the anchor video 120, e.g., by “filling in” invalid pixels or other missing information, correcting temporal inconsistencies, and so on.

Thus, the system 100 uses the video generation neural network 130 to refine or otherwise improve the anchor video 120 rather than directly using the video generation neural network 130 to generate the output video 112 from the input video 102.

For example, the video generation neural network 130 can be a video diffusion neural network. Examples of architectures for the video generation neural network 130 are described in more detail below.

In some cases, the system 100 first fine-tunes the video generation neural network 130 using the anchor video 120, e.g., through a parameter-efficient fine-tuning technique, e.g., low-rank adaptation (LoRA), prior to generating the output video 112. By performing the fine-tuning, the system 100 adapts the video generation neural network 130 to the input video 102 and the anchor video 120, improving the ability of the video generation neural network 130 to correct the potential errors noted above while maintaining semantic consistency with the input video 102 and still accurately reflecting the new camera motion data 104.

The system 100 then uses the fine-tuned video generation neural network 130 to generate the first output video 140.

Fine-tuning the video generation neural network 130 is described in more detail below.

In some cases, the system 100 uses the first output video 140 as the final output video 112.

In some other cases, the system 100 performs an editing process on the first output video 140, e.g., using the video generation neural network 130, e.g., to remove blurriness or other artifacts to generate the final output video 112.

Once generated, the system 100 can use the final output video 112 for any of a variety of purposes. For example, when the system 100 receives the input video 102, the camera motion data 104, or both from a user device, the system 100 can provide the final output video 112 for presentation on the user device. For example, the functionality provided by the system 100 can be made available through a mobile application or a web application running on a mobile device, and the output videos 112 generated by the system 100 can be provided for playback through the mobile or web application. As another example, the system 100 can provide the output video 112 for playback on a wearable device or as part of an augmented reality or virtual reality system.

FIG. 1B shows an example 170 of the performance of the system 100.

In particular, the example 170 shows two input videos 180 and 190 and respective output videos 182 and 192 generated by the system 100 that preserve the content of the input videos 180 and 190 but depict the content from respective novel camera motions. That is, for each input video 180 and 190, the system 100 received an input that included the input video 180 or 190 and corresponding motion data that defined a new camera motion for the input video. The system then processed the input video 180 or 190 and the corresponding motion data to generate the output videos 182 and 192 that preserve the content from the corresponding input videos 180 and 190 but that have camera motion specified by the corresponding motion data.

As can be seen from the example 170, the system 100 is able to generate a new version of the video with a new customized camera trajectory. Moreover, the motion of the subject and scene in the video is preserved, and the scene is observed from angles that are not present in the source video.

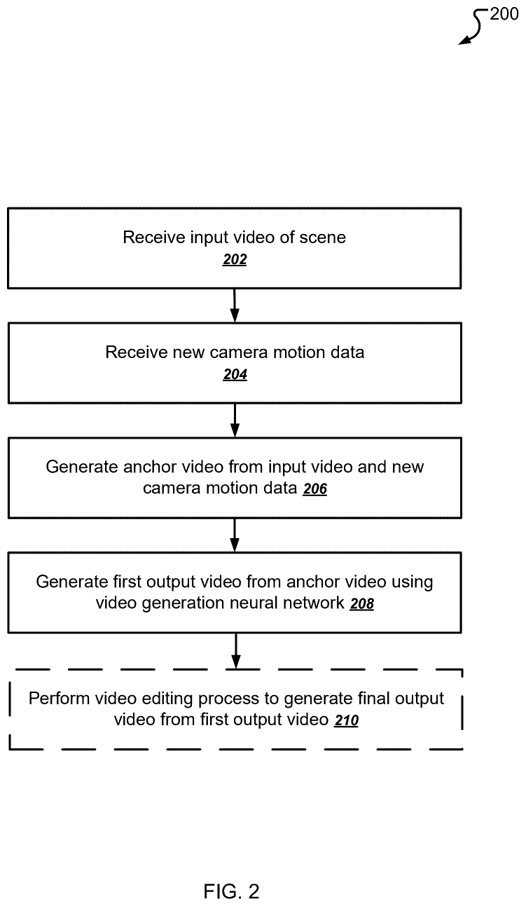

FIG. 2 is a flow diagram of an example process 200 for generating an output video with new camera motion. For convenience, the process 200 will be described as being performed by a system of one or more computers located in one or more locations. For example, a video generation system, e.g., the video generation system 100 of FIG. 1A, appropriately programmed in accordance with this specification, can perform the process 200.

The system receives an input video of a scene with an input camera motion (step 202). As described above, the input video includes a respective input video frame at each of a sequence of time steps.

The system receives new camera motion data specifying a new camera motion that is different from the input camera motion (step 204).

More specifically, the new camera motion data defines a respective camera pose and orientation at the time steps in the input video, with the pose, orientation, or both at one or more of the time steps being different from the corresponding pose or orientation at the same time step specified by the input camera motion of the input video.

The new camera motion data can define the new camera motion in any of a variety of ways.

As one example, the new camera motion data can include a respective set of one or more extrinsic matrices for each of the time steps that defines the pose of the camera at the time step. For example, the set of one or more extrinsic matrices for each of the time steps can include a rotation matrix and a translation matrix that define a camera pose, e.g., the camera position and orientation, at the time step.

As another example, the new camera motion data can include a text sequence that describes desired motion of the camera or a sequence of three-dimensional coordinates of the camera. In these examples, the system can map the camera motion data to extrinsic matrices, e.g., using a machine learning model or a different type of mapping.

The system generates, from the input video of the scene and the new camera motion data, an anchor video with the new camera motion (step 206).

The anchor video includes a respective “anchor” video frame at each of the sequence of time steps.

This video is referred to as an “anchor” because it anchors the final output of the process 200 and serves as a conditioning input for the next stage of the process 200. In other words, the anchor video is a first draft of the final output video that will later be refined by the system. As described above, this first draft can contain artifacts from out-of-scene regions and temporal inconsistencies, which will be corrected in the second stage.

The system can generate the anchor video using any of a variety of techniques.

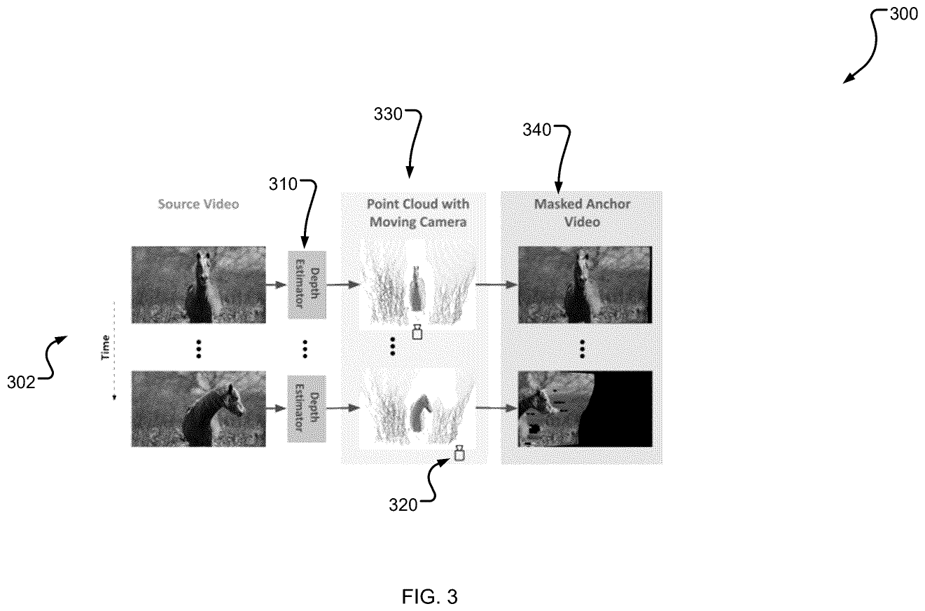

For example, the system can generate the anchor video using point-cloud based techniques. One example of generating the anchor video using point cloud representations is described below with reference to FIG. 3.

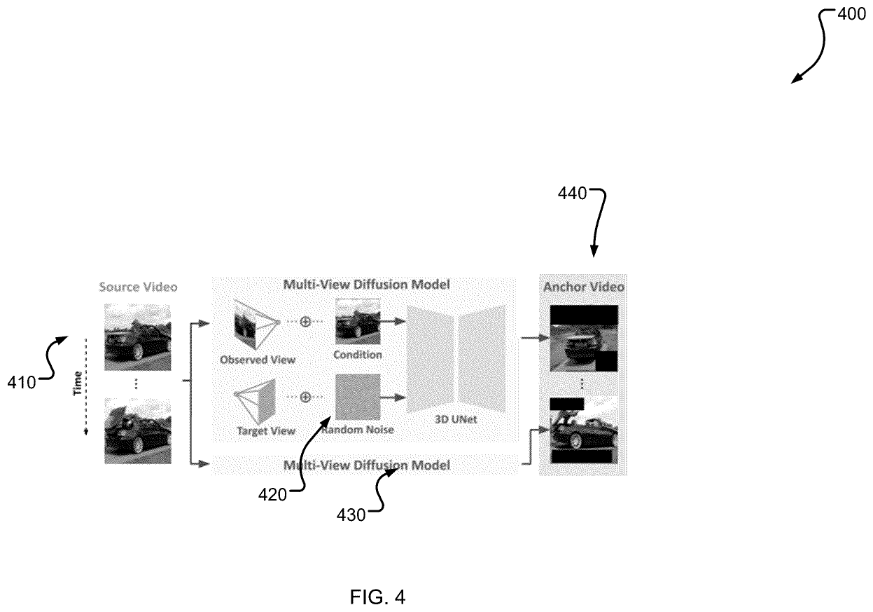

As another example, the system can generate the anchor video using a multi-video diffusion neural network. One example of generating the anchor video using multi-view diffusion is described below with reference to FIG. 4.

The system processes an input that includes the anchor video using a video generation neural network to generate a first output video with the new camera motion (step 208). Optionally, the input can also include one or more additional conditioning inputs characterizing the scene. Examples of such inputs can include text prompts describing the scene, images of the scene taken from a different viewpoint than any of the video frames in the input video, and so on.

Thus, the system uses the video generation neural network to refine or otherwise improve the anchor video rather than directly using the video generation neural network to generate the output video from the input video.

For example, the video generation neural network can be a video diffusion neural network.

In this example, the video diffusion neural network generates the first output video from the anchor video by performing a reverse diffusion process conditioned on the input comprising the anchor video over a plurality of reverse diffusion steps. As a particular example, the video diffusion neural network can perform the reverse diffusion process in a latent space, so that the final output of the reverse diffusion process is a latent representation of the initial output video. In this example, the video diffusion neural network includes a decoder neural network that maps the latent representation of the initial output video generated by performing the reverse diffusion process to the first output video in the pixel space.

Examples of architectures for the video generation neural network 130 are described in more detail below. Performing a reverse diffusion process to generate an output video is also described in more detail below.

In some cases, the system first fine-tunes the video generation neural network using the anchor video, e.g., through a parameter-efficient fine-tuning technique, e.g., low-rank adaptation (LoRA), prior to generating the output video.

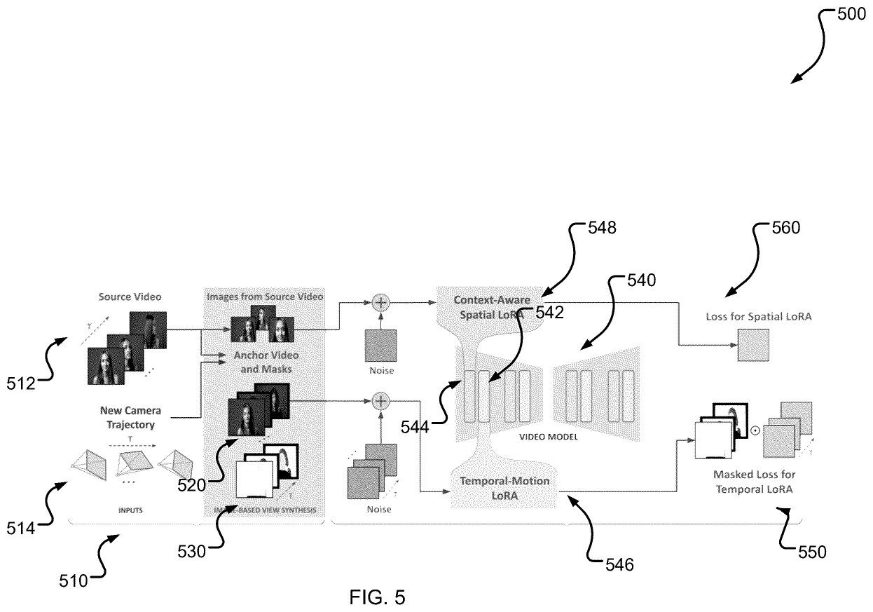

Fine-tuning the neural network is described in more detail below with reference to FIG. 5.

The system then uses the fine-tuned video generation neural network to generate the first output video.

In some cases, the system uses the first output video as the final output video.

In some other cases, the system performs a video editing process on the first output video using the video generation neural network to generate the final output video (step 210).

FIG. 3 shows an example 300 for generating an anchor video with new camera motion using point cloud representations.

As shown in the example 300, the system receives a source video 302. For example, the source video 302 V can be represented as a sequence of N video frames and the i-th video frame, i.e., the video frame at time step i is represented as Iᵢ.

The system applies a depth estimator 310 to each video frame of the source video 302 to generate a depth map D for the input video frame at the time step, e.g., a depth map Dᵢ for video frame Iᵢ. The depth map includes a respective estimated depth value for each pixel of the input video frame.

The depth estimator 310 can be any appropriate depth estimator. For example, the depth estimator 310 can be a pre-trained monocular depth estimation neural network or another neural network that processes an input image to generate a depth map that includes a respective depth estimate for pixel of the input image. One example of such a neural network is described in Shariq Farooq Bhat, Reiner Birkl, Diana Wofk, Peter Wonka, and Matthias Muller. Zoedepth: Zero-shot transfer by combining relative and metric depth. arXiv preprint arXiv:2302.12288, 2023.

The system then uses the depth map to generate a respective point cloud representation 330 that accounts for a moving camera 320. For example, the system can generate the respective point cloud representation of the input video frame at the time step using the depth map for the input video frame at the time step and camera intrinsics data for the camera that captured the input video frame.

More specifically, for the i-th video frame, the system can first generate a point cloud Pᵢ as follows:

$${𝒫}_{i} = ϕ ( [ {I}_{i} , {D}_{i} ] , K ) ,$$

where φ denotes the mapping function from RGBD to a 3D point cloud in the camera coordinate system and K represents the camera's intrinsics.

The system then generates, from each point cloud 330, the corresponding frame 340 of the anchor video. For example, the system can generate the respective anchor video frame at the time step from the respective point cloud representation of the input video frame at the time step, the new camera motion data, and the camera intrinsics data. More specifically, the system can project the point cloud of each frame back onto the anchored camera plane, i.e., the camera plan specified by the new camera pose, to obtain a rendered image with perspective change. In other words, the system can use the new camera pose to rotate and translate each point cloud representation in the camera's coordinate system.

In other words, the system can obtain a rendered image

$${I}_{i}^{a}$$

with the perspective change as follows:

$${I}_{i}^{a} = ψ ( {𝒫}_{i} , K , {P}_{i} ) ,$$

where Pᵢ is the extrinsic matrix for the i-th time step, i.e., as specified by the new camera motion data, and ψ is the function that projects the point cloud of each frame back onto the anchored camera plane.

As shown in the example 300, because of the change in camera movement between the two frames, the anchor frame will generally include invalid pixels, i.e., that have no corresponding pixels in the input video frame. These pixels are shown as all black in the example 300. As described above, the system can generate a validity mask for the anchor video that identifies pixels in the anchor video frames that are invalid due to the new camera motion.

While the process shown in the example 300 can perform well for many videos, when the camera trajectory involves significant rotation and viewpoint changes, point cloud rendering may not generate an accurate anchor video.

To account for this, the system can instead use a multi-video diffusion neural network to generate the anchor video frames of the anchor video.

FIG. 4 shows an example 400 of the generation of the anchor video using a multi-video diffusion neural network.

Specifically, as shown in the example 400, for each frame Iᵢ of the source video, which represents the condition view, along with its corresponding camera parameters P_{cond}, the multi-video diffusion neural network learns to estimate the distribution of the target image.

That is, as shown in the example 400, the system receives a source video 410. For each frame of the source video 410, the system performs a reverse diffusion process starting from random noise 420 using the multi-video diffusion model 430 conditioned on the observed view of the frame, i.e., the camera parameters P_{cond} of the frame, and the target view of the frame, i.e., the extrinsic matrix Pᵢ for the i-th time step, i.e., as specified by the new camera motion data to generate a corresponding frame of the anchor video 440.

For example, as shown in the example 400, the multi-video diffusion model 430 can employ a 3D U-Net as its backbone. As a particular example of this, the 3D U-Net can have been adapted from a 2D text-to-image U-Net by inflating the 2D self-attention mechanism into 3D, allowing it to operate across both 2D spatial dimensions of a given image and across multiple view images.

An example of such a multi-view diffusion neural network is described in Ruiqi Gao, Aleksander Holynski, Philipp Henzler, Arthur Brussee, Ricardo Martin-Brualla, Pratul P. Srinivasan, Jonathan T. Barron, and Ben Poole. Cat3d: Create anything in 3d with multi-view diffusion models. arXiv, 2024

In some implementations, as shown in the example 400, due to the difficulty in obtaining the camera pose with the condition frame, the system can use a raymap with the same dimensions as the condition images, computed relative to the first image's camera pose. This makes the pose representation invariant to rigid transformations. The system can then concatenate the raymaps channel-wise to the corresponding condition image to serve as the final conditioning input for the model 430. An example of this is described in Ruiqi Gao, Aleksander Holynski, Philipp Henzler, Arthur Brussee, Ricardo Martin-Brualla, Pratul P. Srinivasan, Jonathan T. Barron, and Ben Poole. Cat3d: Create anything in 3d with multi-view diffusion models. arXiv, 2024.

As shown in the example 400, because of the change in camera movement between the two frames, the anchor frame will generally include invalid pixels, i.e., that have no corresponding pixels in the input video frame. These pixels are shown as all black in the example 400. As described above, the system can generate a validity mask for the anchor video that identifies pixels in the anchor video frames that are invalid due to the new camera motion.

FIG. 5 shows an example 500 of the operation of the system when generating an output video from an input video by first generating an anchor video.

As shown in the example 500, the system receives inputs 510 that include an input video 512 and new camera motion data 514.

The system uses the inputs 510 to generate an anchor video 520 and a mask 530 for the anchor video that masks out invalid pixels of the frames of the anchor video 520, i.e., that masks out pixels that do not have a corresponding pixel in the input video 512 due to the change in camera motion.

The system then processes the anchor video 520 using a video generation neural network 540 (“video model”).

In the example 500, the video generation neural network 540 is a video diffusion neural network that generates the first output video from the anchor video by performing a reverse diffusion process conditioned on an input that includes the anchor video over a plurality of reverse diffusion steps.

For example, the video diffusion neural network can perform the reverse diffusion process in a latent space and the system can then use a decoder neural network to map the final latent representation in the latent space to a video in the pixel space.

As another example, the video diffusion neural network can perform the reverse diffusion process in the pixel space of the first output video.

Generally, prior to being used by the system, the video generation neural network has been pre-trained on one or more pre-training video generation tasks. For example, when the video generation neural network is a diffusion model, the video generation neural network can have been pre-trained on one or more tasks that require generating one video conditioned on another video on an appropriate diffusion model training objective, e.g., a diffusion score matching objective or another appropriate objective.

In the example 500, prior to processing the input that includes the anchor video using the video generation neural network to generate the first output video with the new camera motion, the system fine-tunes the video generation neural network using the anchor video.

In particular, in the example 500, the system performs parameter-efficient fine-tuning and, more specifically, one or more rounds of low-rank adaptation (LoRA).

More specifically, in the example 500, the video generation neural network includes (i) one or more temporal attention layer blocks 542 and (ii) one or more spatial attention layer blocks 544.

Temporal attention layer blocks perform self-attention across the temporal dimension, i.e., across different video frames within the output video. For example, for each of multiple spatial regions within the latent representation of the output video, each temporal attention layer block can apply self-attention across a set of feature vectors that each correspond to the spatial region within a different one of the frames of the latent representation.

Spatial attention layer blocks perform self-attention within each video frame of the output video independently. For example, for each frame within the latent representation of the output video, each spatial attention layer block can apply self-attention across a set of feature vectors that each correspond to a different spatial region within the frame.

In the example 500, one or more of the temporal attention layer blocks 542 have a respective set 546 of one or more temporal low-rank adaptation (LoRA) weight matrices that the system learns by performing the fine-tuning.

To do this, the system trains the video diffusion neural network on the anchor video to optimize a first diffusion objective to update the respective sets of one or more temporal LoRA weight matrices of the one or more temporal attention layer blocks. More specifically, when the system generates the validity mask 530 for the anchor video that identifies pixels in the anchor video frames that are invalid due to the new camera motion, the system masks out the identified pixels in the validity mask from the first diffusion objective.

More specifically, as described above, the anchor video 520 may exhibit significant artifacts, such as revealed occlusions due to camera movement and temporal inconsistencies such as flickering. To address these issues, the system performs a masked video fine-tuning strategy using temporal motion LoRAs. For example, LoRAs can be applied to the linear layers of the temporal transformer blocks in the video diffusion model.

Since LoRA operates in a low-rank space and the spatial layers remain untouched, the fine-tuning focuses on learning fundamental motion patterns from the anchor video 520 without over-fitting to the entire video. The strong temporal consistency prior from the pre-trained video diffusion model helps minimize temporal inconsistencies.

To perform the training, the system uses a masked diffusion loss, where the invalid regions in the anchor video are excluded from the loss calculation, ensuring that the model only learns from meaningful pixels.

For example, a temporal LoRA loss 550 for the temporal LoRA fine-tuning of the video diffusion neural network can be defined as:

$${ℒ}_{temp} = {𝔼}_{ϵ , t} [ {M}^{a} \cdot ‖ ϵ - {ϵ}_{θ} ( {V}_{t}^{a} , t , y ) ‖ ]$$

where ϵ represents noise added to the anchor video V^{a}, M^{a} is the validity mask for the video,

$${V}_{t}^{a}$$

at denotes the noisy anchor video at reverse diffusion time step t (described in more detail below), y refers to the input that includes the anchor video, and ϵ_{θ} refers to the video diffusion neural network.

In some cases, the system also performs context-aware spatial fine-tuning. In this example, one or more of the spatial attention layer blocks 544 has a respective set of one or more spatial low-rank adaptation (LoRA) weight matrices 548, e.g., LoRA weight matrices for one or more of the linear layers for the spatial attention layer block(s). In this case, as part of the fine-tuning, the system trains the video diffusion neural network on the anchor video 520 to optimize a second diffusion objective to update the respective sets of one or more spatial LoRA weight matrices 548 of the one or more spatial attention layer blocks 544.

For example, the system can train the video diffusion neural network on the source video with the one or more temporal attention blocks 542 disabled to update the respective sets of one or more spatial LoRA weight matrices 548 of the one or more spatial attention layer blocks 544. “Disabling” a layer block refers to not performing the operations of the block when processing a given input, i.e., to setting the block to an identity transformation or otherwise skipping the operations of the block. By disabling the temporal attention blocks 542, the system ensures that the video diffusion neural network updates the latent representation for each frame independently of the other video frames.

That is, although the video diffusion model with masked fine-tuning automatically fills the invalid regions of the anchor video, the filling may not be consistent with the original context or appearance and might appear pixelated.

To address this issue, the system enhances the spatial attention layers 544 of the video diffusion model by incorporating a spatial LoRA, which is fine-tuned on the frames of the source video.

At each training step, the system randomly selects a frame from the source video, and the temporal layers within the video diffusion model are bypassed. The spatial LoRA loss 560 can be defined as follows:

$${ℒ}_{spatial} = {𝔼}_{ϵ , t , i \sim 𝒰 \{ 0 , … , N - 1 \}} [ ‖ ϵ - {ϵ}_{θ} ( ( {I}_{i , t} ) , t , y ) ‖ ] ,$$

where I_{i,t} denotes the noisy frame of the source video at diffusion time step t (described in more detail below), and U refers to the uniform distribution over the input video frames.

Thus, the spatial LoRA captures the original context from the source video, ensuring seamless integration of filled pixels with the original pixels.

After finishing the fine-tuning, the system can directly use the video diffusion model to generate the desired video with new camera motion while maintaining high visual quality.

Optionally, as a post-processing stage to further eliminate blurriness, the system can use the video diffusion model with spatial LoRA while omitting (i.e., disabling) the temporal LoRA to perform editing on the output video to generate the final output. For example, the system can perform SDediting on the output video, e.g., as described in Chenlin Meng, Yutong He, Yang Song, Jiaming Song, Jiajun Wu, Jun-Yan Zhu, and Stefano Ermon. Sdedit: Guided image synthesis and editing with stochastic differential equations. arXiv preprint arXiv:2108.01073, 2021, using the video diffusion model with the temporal LoRA disabled. Thus, in this example, the system edits each frame of the first output video independently to remove any undesirable artifacts of the generation process.

Typically, SD-editing introduces randomness that alters the appearance of the subject, but since the system has fine-tuned spatial LoRA on the source video, the SD-editing preserves the original appearance while simultaneously removing the blur.

An example of performing a reverse diffusion process now follows. The system can perform the reverse diffusion process described below to (i) generate each video frame of the anchor video using the multi-view diffusion network, (ii) generate the first output video using the video diffusion neural network, or both. In example (i), the data item referred to below is a video frame of the anchor video. In example (ii), the data item referred to below is the first output video.

To perform the reverse diffusion process, the system initializes a representation of the data item. For example, the system can sample each value in the representation from a noise distribution, e.g., a Gaussian distribution.

The system then updates the representation at each of a plurality of reverse diffusion steps (also referred to as “iterations” or “updating iterations”) using the diffusion neural network, e.g., the multi-view diffusion neural network or the video diffusion neural network. Each reverse diffusion step is associated with a noise level for the iteration. Generally, each updating iteration has a corresponding time step t and the noise level for the iteration depends on the time step. For example, the noise level can be a decreasing function of the time step t. Examples of such functions include a linear function, a cosine function, and a sigmoid function. Thus, early iterations are associated with higher noise levels and later iterations are associated with lower noise levels, resulting in the diffusion neural network gradually “denoising” the representation to generate the final representation.

As part of the updating at any given step, the system generates a denoising output for the reverse diffusion step.

The system then updates the representation of the data item using the denoising output for the reverse diffusion step.

For example, the system can map the denoising output to an initial updated representation and then apply a diffusion sampler, e.g., the DDPM (Denoising Diffusion Probabilistic Model) sampler, the DDIM (Denoising Diffusion Implicit Model) sampler or another appropriate sampler, to the initial updated representation to generate an updated representation.

Optionally, after the last reverse diffusion iteration, the system can refrain from using the diffusion sampler and can instead use the initial updated representation as the updated representation.

To generate the denoising output, the system processes a diffusion input for the reverse diffusion step that includes the representation of the data item and the conditioning input using the diffusion neural network to generate a denoising output, which can be used as the final denoising output or combined with one or more other denoising outputs, e.g., through classifier free guidance, to generate the final denoising output.

More specifically, the diffusion neural network can be any appropriate diffusion neural network that is configured to receive an input that includes a current (noisy) representation of a data item and a conditioning input that includes text and to generate a denoising output.

For example, the diffusion neural network can include a text encoder neural network configured to process the text input to generate an encoded representation of the text input and an diffusion neural network configured to generate the data item over a plurality of sampling steps conditioned on the encoded representation of the text input.

In some implementations, the diffusion neural network performs a diffusion process in pixel space, so that the images (“representations”) operated on and generated by the diffusion neural network have values for each pixel that specify color values, e.g., RGB values or another color encoding scheme.

Examples of such diffusion neural networks include Imagen.

In some other implementations, the diffusion neural network performs a diffusion process in latent space, e.g., in a latent space that is lower-dimensional than the pixel space. That is, the images (“representations”) operated on by the diffusion neural network are latent images and the values for the pixels of the images are learned, latent values rather than color values.

Examples of such diffusion neural networks include mobileDiffusion.

In these implementations, during training, the diffusion neural network can be associated with an image encoder to encode training images into the latent space and, after training and to generate new target images, a decoder neural network that receives an input that includes a latent representation of an image and decodes the latent representation to reconstruct the image. For example, both the encoder and the decoder neural networks can be convolutional neural networks, can be self-attention neural networks, or can include both convolutional and self-attention layers.

The diffusion neural network can have any appropriate architecture that allows the neural network to map a diffusion input that includes an input representation of a data item and to map the input representation to a denoising output that has the same dimensionality as the input representation.

For example, the diffusion neural network can be a convolutional neural network, e.g., a U-Net or other architecture that maps one input of a given dimensionality to an output of the same dimensionality.

As another example, the diffusion neural network can be a Transformer neural network that processes the diffusion input through a set of self-attention layers to generate the denoising output.

As yet another example, the diffusion neural network can include both convolutional layers and self-attention layers.

The diffusion neural network can be conditioned on the conditioning input in any of a variety of ways.

As one example, the diffusion neural network can use an encoder neural network to generate one or more embeddings that represent the conditioning input and the diffusion neural network can include one or more cross-attention layers that each cross-attend into the one or more embeddings.

As another example, the diffusion neural network can include one or more other types of neural network layers that are conditioned on the one or more embeddings. Examples of such layers include Feature-wise Linear Modulation (FILM) layers, layers with conditional gated activation functions, and so on.

As another example, as will be described in more detail below, the output(s) of the encoder(s) when encoding the conditioning input can be combined, e.g., through a weighted sum, with features of the representation of the data item, and the combined features can be processed by the remainder of the diffusion neural network.

An embedding, as used in this specification, is an ordered collection of numerical values, e.g., a vector of floating-point values or other types of values.

The diffusion input at any given updating iteration can also include data defining a noise level for the iteration. Generally, each updating iteration has a corresponding time step t and the noise level for the iteration depends on the time step. For example, the noise level can be a decreasing function of the time step t. Examples of such functions include a linear function, a cosine function, and a sigmoid function. In these cases, data identifying the noise level, the time step, or both can be embedded using an appropriate neural network, e.g., a multi-layer perceptron (MLP) and used to condition the diffusion neural network as described above for the conditioning input.

Generally, the denoising output that is generated by the diffusion neural network defines an estimate of the final data item given the current representation of the data item.

In some implementations, the denoising output is an estimate of the noise component of the current representation, i.e., the noise that needs to be combined with, e.g., added to or subtracted to, the final representation to generate the current representation.

In some other implementations, the denoising output is an estimate of the final representation given the current representation, i.e., an estimate of the representation that would result from removing the noise component of the current representation.

In yet other implementations, the system parametrizes the denoising output differently, e.g., using a v-parameterization (Salimans and Ho arXiv: 2202.00512, 2022, section 4; Appendix D) or another appropriate parameterization.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving an input video of a scene with an input camera motion, wherein the input video comprises a respective input video frame at each of a sequence of time steps;
receiving new camera motion data specifying a new camera motion that is different from the input camera motion;
generating, from the input video of the scene and the new camera motion data, an anchor video with the new camera motion, wherein the anchor video comprises a respective anchor video frame at each of the sequence of time steps; and
processing an input comprising the anchor video using a video generation neural network to generate a first output video with the new camera motion.

2. The method of claim 1, wherein the video generation neural network is a video diffusion neural network that generates the first output video from the anchor video by performing a reverse diffusion process conditioned on the input comprising the anchor video over a plurality of reverse diffusion steps.

3. The method of claim 2, wherein the video diffusion neural network performs the reverse diffusion process in a latent space.

4. The method of claim 2, wherein the video diffusion neural network performs the reverse diffusion process in a pixel space of the first output video.

5. The method of claim 2, wherein the input that comprises the anchor video further comprises one or more additional conditioning inputs characterizing the scene.

6. The method of claim 2, wherein the video generation neural network has been pre-trained on one or more pre-training video generation tasks.

7. The method of claim 6, further comprising:
prior to processing the input comprising the anchor video using the video generation neural network to generate the first output video with the new camera motion, fine-tuning the video generation neural network using the anchor video.

8. The method of claim 7, wherein the video generation neural network comprises (i) one or more temporal attention layer blocks and (ii) one or more spatial attention layer blocks.

9. The method of claim 8, wherein each of the one or more temporal attention layer blocks have a respective set of one or more temporal low-rank adaptation (LoRA) weight matrices, and wherein fine-tuning the video generation neural network using the anchor video comprises:
training the video generation neural network on the anchor video to optimize a first diffusion objective to update the respective sets of one or more temporal LoRA weight matrices of the one or more temporal attention layer blocks.

10. The method of claim 9, further comprising:
generating a validity mask for the anchor video that identifies pixels in the anchor video frames that are invalid due to the new camera motion.

11. The method of claim 10, wherein the identified pixels in the validity mask are masked out from the first diffusion objective.

12. The method of claim 8, wherein each of the one or more spatial attention layer blocks have a respective set of one or more spatial low-rank adaptation (LoRA) weight matrices, and wherein fine-tuning the video generation neural network using the anchor video comprises:
training the video generation neural network on the input video to optimize a second diffusion objective to update the respective sets of one or more spatial LoRA weight matrices of the one or more spatial attention layer blocks.

13. The method of claim 12, wherein training the video generation neural network on the input video to optimize a second diffusion objective to update the respective sets of one or more spatial LoRA weight matrices of the one or more spatial attention layer blocks comprises:
training the video generation neural network on the input video with the one or more temporal attention blocks disabled to update the respective sets of one or more spatial LoRA weight matrices of the one or more spatial attention layer blocks.

14. The method of claim 12, further comprising:
performing a video editing process on the first output video using the video generation neural network with the respective sets of one or more spatial LoRA weight matrices of the one or more spatial attention layer blocks disabled to generate a second output video.

15. The method of claim 1, wherein generating, from the input video of the scene and the new camera motion data, an anchor video with the new camera motion comprises:
processing the input video and the new camera motion data using a multi-view diffusion neural network to generate the anchor video.

16. The method of claim 1, wherein generating, from the input video of the scene and the new camera motion data, an anchor video with the new camera motion comprises, for each input time steps:
processing the input video frame at the time step using a depth estimator to generate a depth map for the input video frame at the time step;
generating a respective point cloud representation of the input video frame at the time step using the depth map for the input video frame at the time step; and
generating the respective anchor video frame at the time step from the respective point cloud representation of the input video frame at the time step and the new camera motion data.

17. The method of claim 16, wherein generating a respective point cloud representation of the input video frame at the time step using the depth map for the input video frame at the time step comprises:
generating a respective point cloud representation of the input video frame at the time step using the depth map for the input video frame at the time step and camera intrinsics data for a camera that captured the input video frame.

18. The method of claim 1, wherein the new camera motion data comprises a respective set of one or more extrinsic matrices for each of the time steps, and wherein the respective set of one or more extrinsic matrices for each of the time steps comprises a rotation matrix and a translation matrix.

19. A system comprising one or more computers and one or more storage devices storing instructions that when executed by the one or more computers cause the one or more computers to perform operations comprising:
receiving an input video of a scene with an input camera motion, wherein the input video comprises a respective input video frame at each of a sequence of time steps;
receiving new camera motion data specifying a new camera motion that is different from the input camera motion;
generating, from the input video of the scene and the new camera motion data, an anchor video with the new camera motion, wherein the anchor video comprises a respective anchor video frame at each of the sequence of time steps; and
processing an input comprising the anchor video using a video generation neural network to generate a first output video with the new camera motion.

20. One or more non-transitory computer-readable media storing instructions that when executed by one or more computers cause the one or more computers to perform operations comprising:
receiving an input video of a scene with an input camera motion, wherein the input video comprises a respective input video frame at each of a sequence of time steps;
receiving new camera motion data specifying a new camera motion that is different from the input camera motion;
generating, from the input video of the scene and the new camera motion data, an anchor video with the new camera motion, wherein the anchor video comprises a respective anchor video frame at each of the sequence of time steps; and
processing an input comprising the anchor video using a video generation neural network to generate a first output video with the new camera motion.
